(19) United States
(12) Patent Application Publication
(10) Pub. No.: US 2011/0163679 A1
(43) Pub. Date: Jul. 7, 2011

(54) AC LIGHT EMITTING DIODE DEVICE HAVING INTEGRATED PASSIVE DEVICE

(75) Inventors: Chung-I Chiang, Taoyuan (TW); Hung-Yi Lin, Taoyuan (TW); Hsien-Lung Ho, Taoyuan (TW)

(73) Assignee: WALSIN LIHWA CORPORATION, Taoyuan (TW)

(21) Appl. No.: 12/683,490

(22) Filed: Jan. 7, 2010

(51) Int. Cl. H05B 37/02

(52) U.S. Cl. 315/185 R; 315/294

(57) ABSTRACT

A light emitting diode device is disclosed in the present invention. The device includes a substrate, an integrated passive device, at least four rectifying diodes and several light emitting diodes. The rectifying diodes form a bridge rectifier to rectify an external alternating current (AC) inputted into a direct current so that the light emitting diodes can lighten. Furthermore, the light emitting diode device has a Zener diode, formed on the substrate and connected with the integrated passive device for regulating the direct current. It can also have a varistor, connected with the Zener diode in parallel, for protecting the light emitting diode device from surges.

### FIELD OF THE INVENTION

The present invention relates generally to a light emitting diode device. More specifically, the present invention relates to a light emitting diode device having an integrated passive device so that the light emitting diode device can connect to an external alternating current without a transformer.

### BACKGROUND OF THE INVENTION

Light emitting diode (LED) has commonly been used in many fields for different purposes, such as lightening, signaling and displaying. The first commercial LEDs were commonly used as replacements for incandescent indicators, and in seven-segment displays, first in expensive equipment such as laboratory and electronics test equipment, then later in such appliances as TVs, radios, telephones, calculators, and even watches. These red LEDs were bright enough only for use as indicators, as the light output was not enough to illuminate an area. Later, other colors became widely available and also appeared in appliances and equipment. As the LED materials technology became more advanced, the light output was increased, while maintaining the efficiency and the reliability to an acceptable level. The invention and development of the high power white light LED led to use for illumination.

Although LED industry made a great leap during last two decades, it is still room for improvement if people need LEDs to be integrated in their life well and help people's life more convenient. There is an example to show how it can be: We use alternating current (AC) for daily life. No doubt, it is a clean energy. However, LED can only use low voltage direct current (DC). When devices using LED are working, the inputted AC has to be transformed into DC. Since LED doesn't play the key role in these complicated devices, a well-designed circuit with passive devices should be used to transform the current and lower the voltage. Otherwise, batteries must be applied. However, if LED is the leading role, for example, for lightening, how to use AC without complicated devices is a hot topic currently.

By intuition, a LED chip can be designed and manufactured to use AC directly. Please refer to FIG. 1. US Patent Application Pub. No. 2008/0129198 shows a LED device dice. It includes a multi-layer stack of materials having a p-layer, an n-layer, and a p-n junction for emission of light. The LED dice also includes a p-electrode and an n-electrode for electrical connection between the respective p-layer and n-layer with an AC power source, and a capacitor located between one of the p-layer and n-layer and its respective electrode. The LED can work with AC input from the electrode. However, such a design can be applied only to a low voltage (usually, the working voltage is under 5V). In practice, AC voltage is 110V˜220V output from plugs. Hence, only modification of a LED chip structure is not enough. Other devices, such as a transformer, are needed.

Please refer to FIG. 2. Taiwan Utility Model No. M242930 provides a driver for LED with a non-polar high voltage capacitor to replace traditional transformer. The series numbers of a strip of LEDs 10 under acceptable voltage range are unrestricted, according to the theory of capacitor impedance and voltage division. A filter capacitor 25b is in parallel with a strip of LEDs 10, used for eliminating the spark on power line. A high voltage capacitor 25a is connected in series with the filter capacitor 25b and the strip of LEDs 10, used for substituting a transformer. A bridge rectifier 12 is placed among LEDs 10, filter capacitor 25b and high voltage capacitor 25a, to rectify alternative current from power source 14a and 14b into direct current to drive LED. Because of no transformer design, the volume of whole driver is decreased. No heat is generated and low electromagnetic radiation is produced. The driver is operated by an ordinary power source. Although it provides a device which is able to transform and rectify an AC into a DC, filter and regulate the DC, it still needs a plurality of LEDs 10 linked in series. If one of the LEDs 10 can't work but is conducted, the rest LEDs 10 bear higher voltage. It causes to decrease lift time of the device. Meanwhile, passive deices, such as capacitors 25a and 25b, are wildly arranged over the whole driver. Light from the LEDs will be influenced by the design.

Another modification of AC LED is shown in Taiwan Patent No. I297220, Please see FIG. 3. A LED device connected to an AC power source 13 has a Wheatstone Bridge 11 and a lighting unit 12. The Wheatstone Bridge 11 is composed of four rectifying elements 110 which have characteristics of high reverse breakdown voltage and low forward threshold voltage. The lighting unit 12 comprises a plurality of LEDs 120 connected in series. This invention provides more features on the rectifier. Due to similar structure, I297220 faces the same problem as that of M242930.

Next, a related invention is provided in Taiwan Patent Application Pub. No. 200806079 as shown in FIG. 4. The invention related to a driving circuit for LED. A driving circuit 30 has a full-wave rectification circuit 33 for rectifying an AC signal from an AC signal source 31. Then, a voltage adjusting device 35 is used to adjust the rectified signal. Finally, a fixed current circuit 37 is used to provide a fixed and stable current to a plurality of LEDs 39. Therefore, the driving circuit 30 can be applied to any lamp holder. There is a drawback that the size would be large since the elements mentioned above can not be integrated.

Hence, an AC LED device having functions of voltage transformation, rectification, filtering and regulation is desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a light emitting diode device comprising: a substrate; an integrated passive device, formed on the substrate; at least four rectifying diodes, formed on the substrate and electrically connected with the integrated passive device, wherein the rectifying diodes are linked to form a bridge rectifier for rectifying an external alternating current (AC) inputted from two first nodes into a direct current to be outputted via two second nodes, and wherein the direct current is smoothed by the integrated passive device; and a plurality of light emitting diodes, connected with each other in series or parallel and applied with the direct current, for lightening.

Preferably, the present invention further comprises a Zener diode, formed on the substrate and connected with the integrated passive device via the second nodes, for regulating the direct current.

Preferably, the present invention further comprises a varistor, connected with the Zener diode in parallel, for protecting the light emitting diode device from surges.

Preferably, the integrated passive device comprises at least one capacitor connected with the bridge rectifier in parallel and at least one resistor connected with the bridge rectifier in series or parallel.

Preferably, the integrated passive device comprises at least one inductor connected with the bridge rectifier in series and at least one resistor connected with the bridge rectifier in series or parallel.

Preferably, integrated passive device comprises at least one capacitor connected with the bridge rectifier in parallel, at least one inductor connected with the bridge rectifier in series, and at least one resistor connected with the bridge rectifier in series or parallel.

Preferably, substrate is made of glass, silicon, ceramic material and printed circuit board.

Preferably, the substrate has a plurality of cavities to accommodate the light emitting diodes.

Preferably, the rectifying diodes are light emitting diodes.

Preferably, the rectifying diodes are formed integratedly or discretely.

### BRIEF DESCRIPTION OF THE DRAWINGS

FIG. 1 illustrates a prior art.

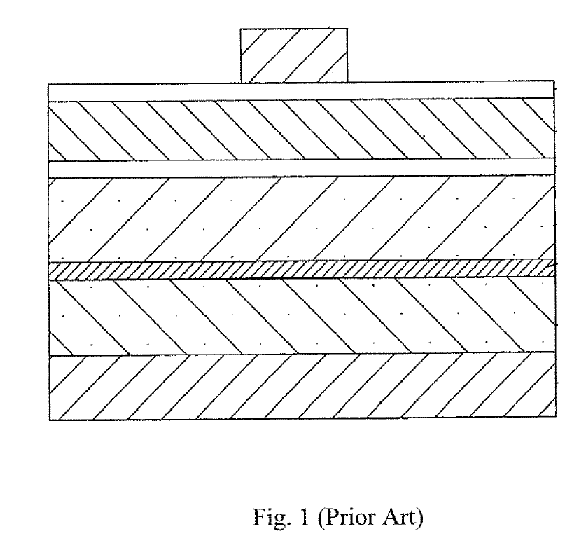

FIG. 2 illustrates another prior art.

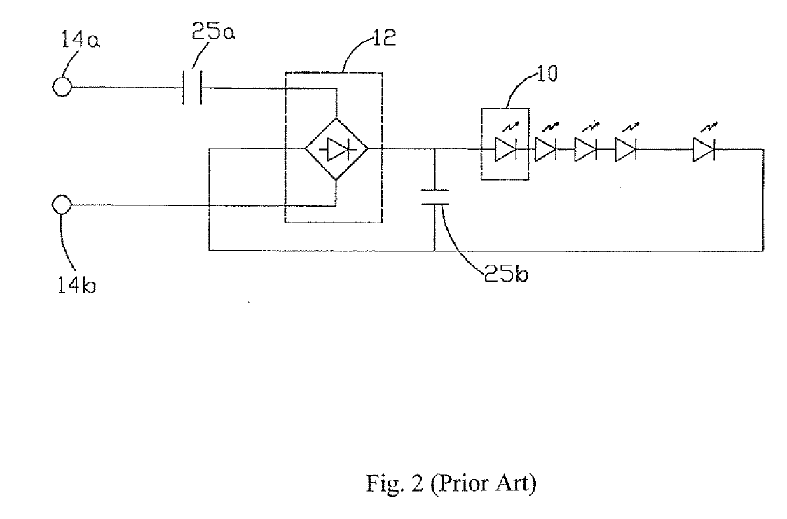

FIG. 3 illustrates another prior art.

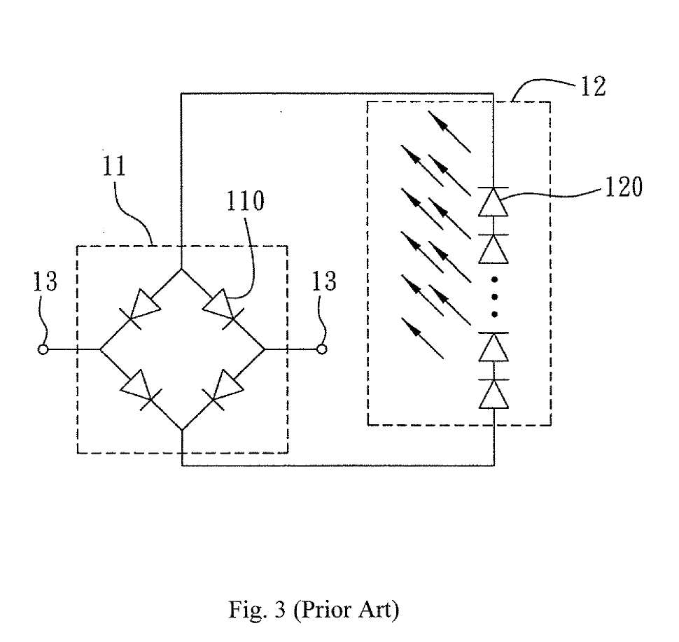

FIG. 4 illustrates another prior art.

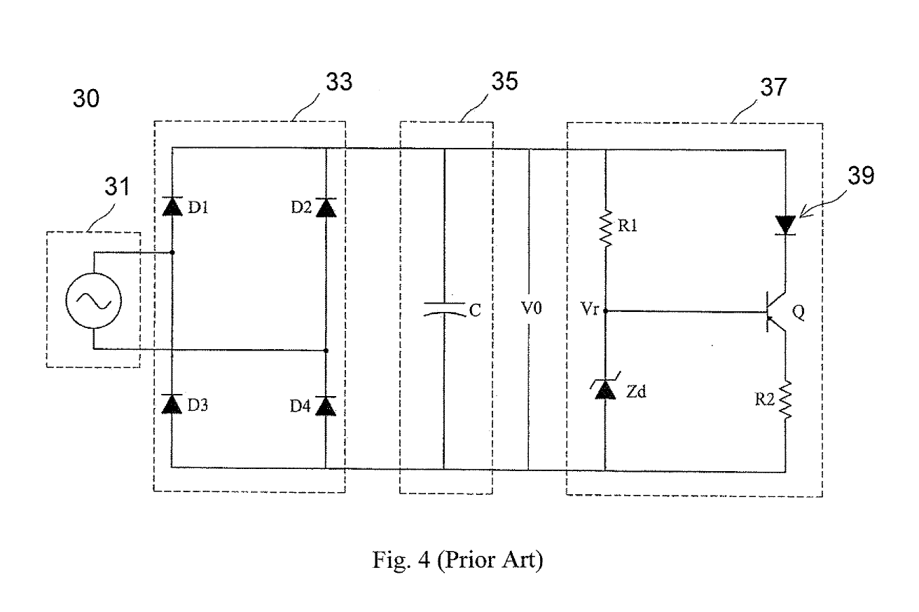

FIG. 5 shows a first embodiment of the present invention.

FIG. 6 shows a design of a passive device in the first embodiment.

FIG. 7 shows another design of the passive device in the first embodiment.

FIG. 8 shows still another design of the passive device in the first embodiment.

FIG. 9 shows a second embodiment of the present invention.

FIG. 10 shows a third embodiment of the present invention.

FIG. 11 shows a fourth embodiment of the present invention.

FIG. 12 shows a fifth embodiment of the present invention.

### DETAILED DESCRIPTION OF THE PREFERRED EMBODIMENTS

For better understanding of the present invention, five embodiments are described below.

### First Embodiment

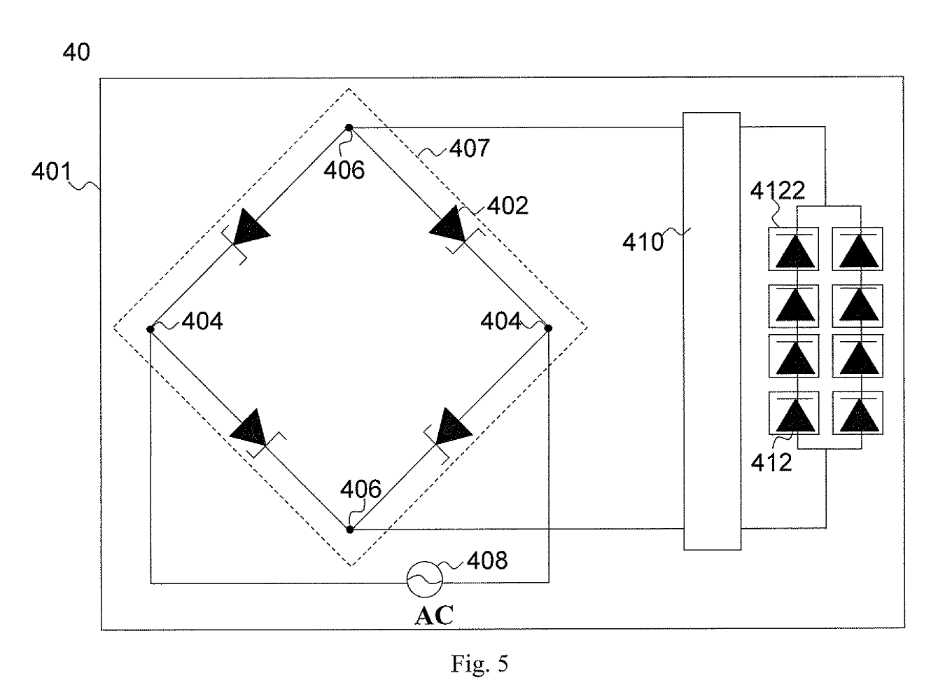

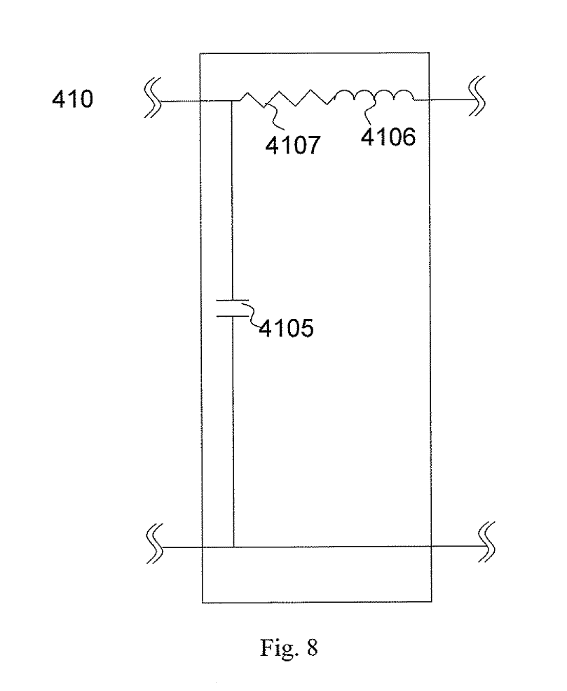

Please refer to FIG. 5 to FIG. 8. A first embodiment is illustrated. FIG. 5 shows a light emitting diode device 40. It has a substrate 401, four Zener diodes 402, an integrated passive device 410 and eight light emitting diodes. 412. The Zener diodes 402, integrated passive device 410 and light emitting diodes. 412 are formed on the substrate 401.

Here, the substrate 401 is a printed circuit board. In practice, the substrate 401 can be any form and made of glass, silicon or ceramic material. The four Zener diodes 402 are electrically connected with the integrated passive device 410 and form a bridge rectifier 407. The bridge rectifier 407 further comprises a pair of first nodes 404 and a pair of second nodes 406. The first nodes 404 are linked to an external alternating current (AC) source 408, the AC is rectified into a direct current (DC) and the DC is outputted via the second nodes 406. In the present embodiment, the four Zener diodes 402 of the bridge rectifier 407 are formed discretely. They can also be integrated into a unit for rectifying purpose.

Please notice that the AC source 408 is not a part of the present invention. Since FIG. 5 is a plan view of the first embodiment, AC source 408 seems formed on the substrate 401. Similar sketches are used to illustrate an AC source in other embodiments.

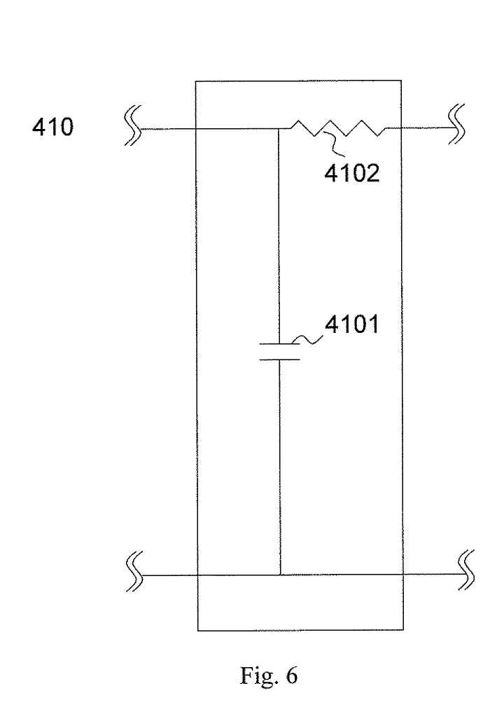

The integrated passive device 410 is connected to bridge rectifier 407 via the second nodes 406 and used to smoothen and regulate the DC. In order to understand how it works, please see FIG. 6 to FIG. 8. These three sketches illustrate different design inside the integrated passive device 410 for different purposes. As shown in FIG. 6, a capacitor 4101 is connected with the bridge rectifier 407 in parallel and a resistor 4102 is connected with the bridge rectifier 407 in series. It should be noticed that the number of capacitor 4101 or resistor 4102 is not limited to one. The resistor 4102 can be connected to the bridge rectifier 407 in parallel.

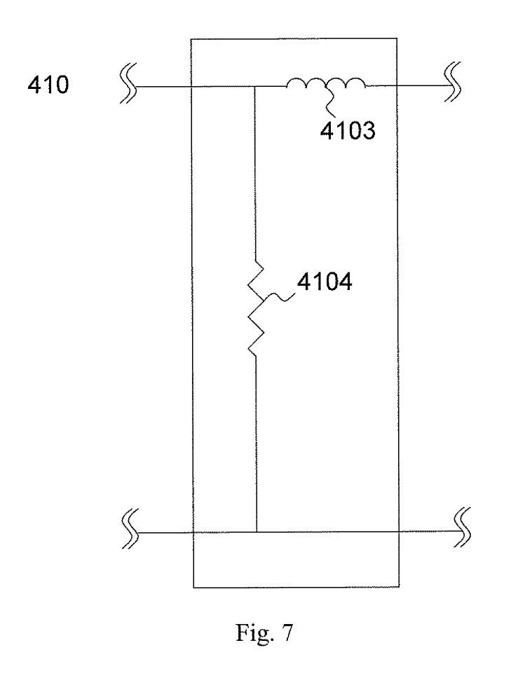

In another design, the integrated passive device 410 comprises an inductor 4103 connected with the bridge rectifier 407 in series and a resistor 4104 connected with the bridge rectifier 407 in parallel. Please refer to FIG. 7. Of course, the number of the inductor 4103 or resistor 4104 is not limited to one. The resistor 4104 can be connected to the bridge rectifier 407 in series.

In still another design, the integrated passive device 410 can comprise a capacitor 4105 connected with the bridge rectifier 407 in parallel, an inductor 4106 connected with the bridge rectifier 407 in series, and a resistor 4107 connected with the bridge rectifier 407 in parallel. Same as the two designs mentioned above, the number of the capacitor 4105, inductor 4106 or resistor 4107 is not limited to one. The resistor 4107 can be connected to the bridge rectifier 407 in series.

Please refer to FIG. 5 again. After the DC current passes through the integrated passive device 410, the light emitting diodes 412 receive stable DC and lighten. The eight light emitting diodes 412 form two groups. Each group is composed of four light emitting diodes 412 in series. The two groups are linked in parallel. Both groups bear the same current. Every light emitting diode 412 share the same voltage. The quantity of light emitting diodes 412 in each group is not limited to four. Depending on the AC voltage input, the quantity can be adjusted to get the best working voltage for each light emitting diode 412. Meanwhile, the light emitting diodes 412 divided into two groups makes them able to carry a larger DC from the integrated passive device 410. There is no doubt that the rectified DC can be further reduced by the integrated passive device 410. It is worthy to be noticed that a cavity 4122 is used to accommodate one light emitting diode 412 in practice.

### Second Embodiment

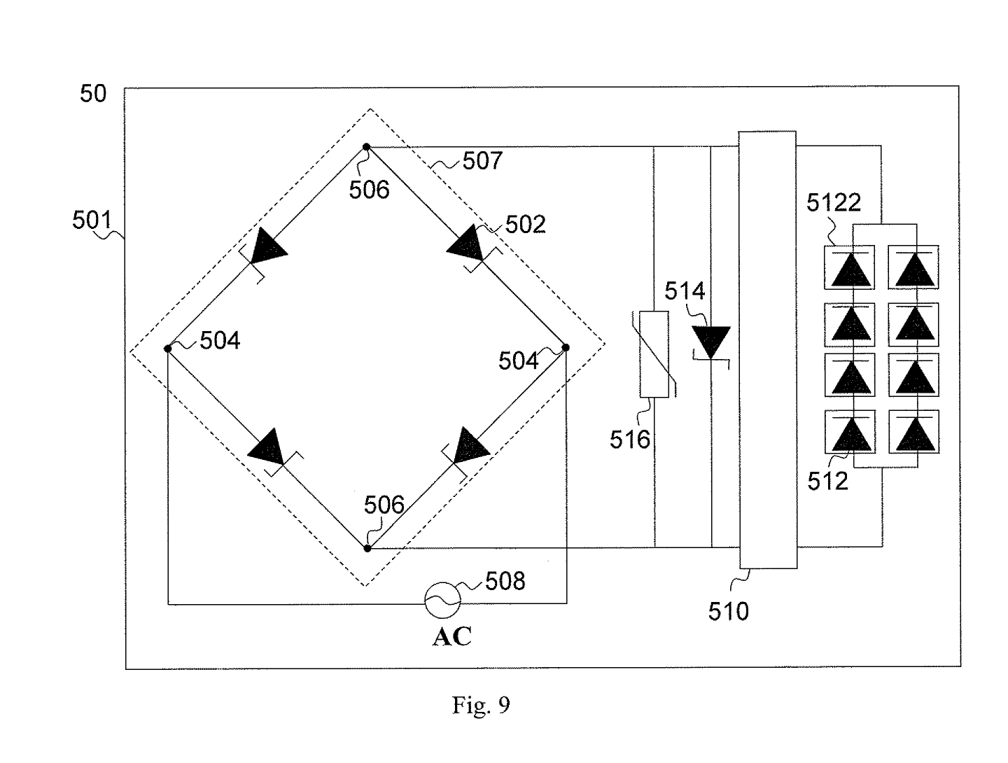

A second embodiment is shown in FIG. 9. Similarly, a light emitting diode device 50 has a substrate 501, four Zener diodes 502, an integrated passive device 510 and eight light emitting diodes. 512. The Zener diodes 502, integrated passive device 510 and light emitting diodes. 512 are formed on the substrate 501.

The substrate 501 is a printed circuit board. The four Zener diodes 502 are electrically connected with the integrated passive device 510 and form a bridge rectifier 507. The bridge rectifier 507 further comprises a pair of first nodes 504 and a pair of second nodes 506. The first nodes 504 are linked to an external AC source 508, the AC is rectified into a DC and the DC is outputted via the second nodes 506. As mentioned above the AC source 508 is not a part of the present invention.

The integrated passive device 510 is connected to bridge rectifier 507 via the second nodes 506 and used to smoothen and regulate the DC. Design of the integrated passive device 510 is the same as that of the first embodiment. Therefore, description thereof is omitted.

In comparison with the first embodiment, a Zener diode 514 and a varistor 516 are installed. The Zener diode 514 is connected with the integrated passive device 510 via the second nodes 506 in order to regulate the DC. Meanwhile, the varistor 516 is connected with the Zener diode in parallel, for protecting the light emitting diode device 50 from surges.

Similarly, the eight light emitting diodes 512 form two groups and are installed in cavities 5122 as the first embodiment.

### Third Embodiment

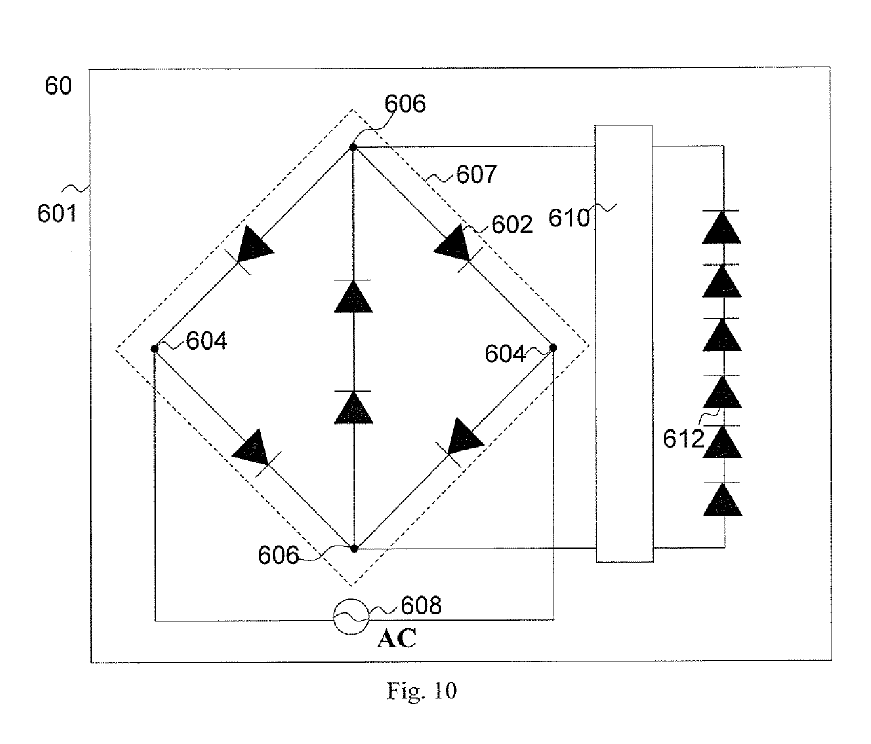

A third embodiment is shown in FIG. 10. A light emitting diode device 60 has a substrate 601, twelve light emitting diodes 602 and 612, and an integrated passive device 610. The integrated passive device 610 and light emitting diodes 602 are formed on the substrate 601.

The substrate 601 is a printed circuit board. Four light emitting diodes 602 are electrically connected with the integrated passive device 610 and form a bridge rectifier 607. The bridge rectifier 607 further comprises a pair of first nodes 604 and a pair of second nodes 606. The first nodes 604 are linked to an external AC source 608, the AC is rectified into a DC and the DC is outputted via the second nodes 606. As mentioned above, the AC source 608 is not a part of the present invention. Here, diodes used to form the bridge rectifier 607 are not restricted to Zener diodes. Light emitting diodes can be used instead. It means that the bridge rectifier 607 can lighten when rectifying. Two of the light emitting diodes 602 are provided in the bridge rectifier 607. Therefore, when the bridge rectifier 607 works, DC inside itself can be provided to the two light emitting diodes 602 for lightening. The rest six light emitting diodes 602 can receive stable DC to lighten. In the present embodiment, the light emitting diodes 602 are connected with each other in series. Hence, the design can bear a high DC.

The integrated passive device 610 is connected to bridge rectifier 607 via the second nodes 606 and used to smoothen and regulate the DC. Design of the integrated passive device 610 is the same as that of the first and second embodiment. Therefore, the description thereof is omitted.

### Fourth Embodiment

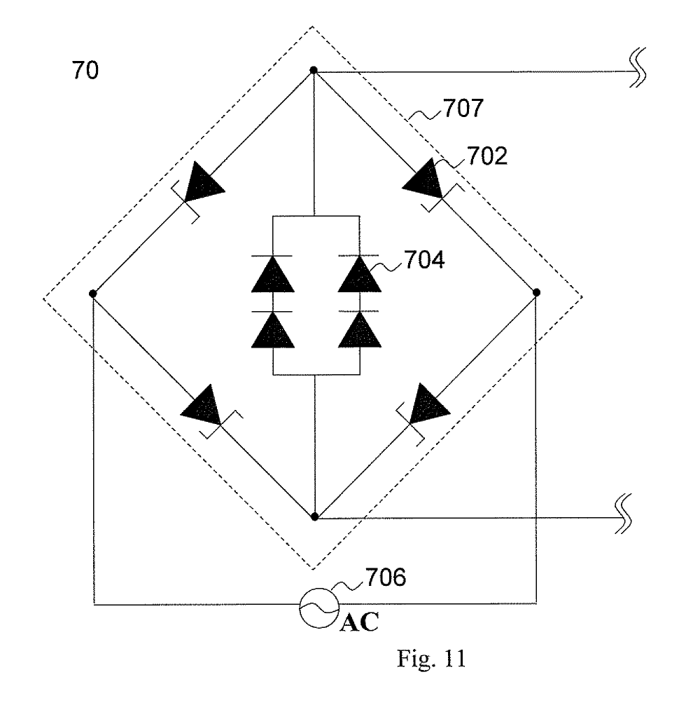

A fourth embodiment is used to discuss diode arrangement in a rectifier. Please see FIG. 11. A rectifier 707 of a light emitting diode device 70 is provided. The rectifier 707 is composed of four Zener diodes 702 and linked to an external AC 706 for rectifying. There are four light emitting diodes 704 installed inside the rectifier 707. Two light emitting diodes 704 form a group and linked in series. Two groups are connected in parallel. When the rectifier 707 works, DC inside the rectifier 707 will lighten the light emitting diodes 704. The light emitting diodes 704 can have any arrangement, i.e., series or parallel.

### Fifth Embodiment

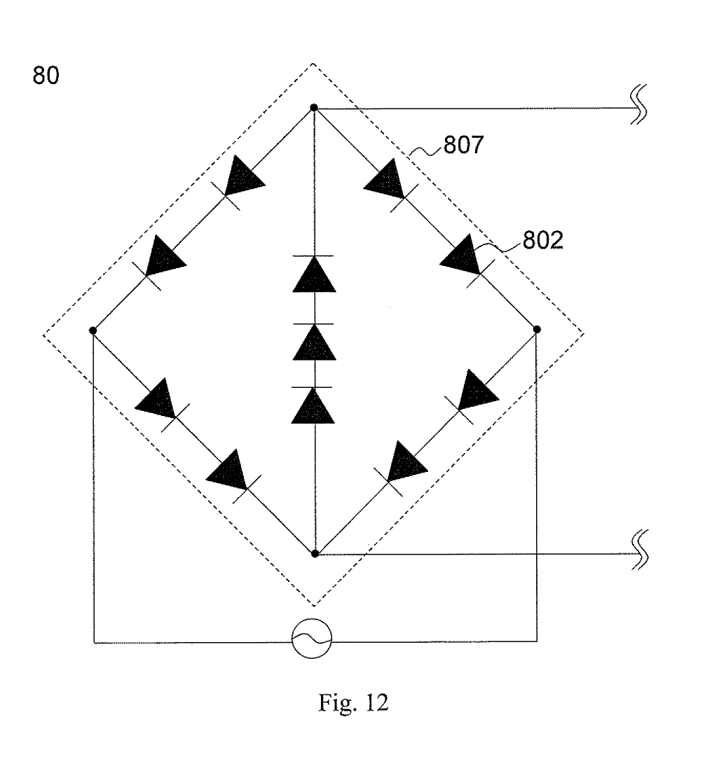

A fifth embodiment is provided in FIG. 12 to discuss another design of a rectifier according to the present invention. A rectifier 807 of a light emitting diode device 80 comprises eleven light emitting diodes 802. Eight light emitting diodes 802 are used for rectifying. The rest three light emitting diodes 802 are installed inside the rectifier 807. Similarly, the three light emitting diodes are lightened by the DC in the rectifier 807. It should be noticed that the two light emitting diodes 802 are used to replace one Zener diode used in the fourth embodiment as long as the effect is equivalent.

While the invention has been described in terms of what is presently considered to be the most practical and preferred embodiments, it is understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A light emitting diode device, comprising:
a substrate;
an integrated passive device, formed on the substrate;
at least four rectifying diodes, formed on the substrate and electrically connected with the integrated passive device, wherein the rectifying diodes are linked to form a bridge rectifier for rectifying an external alternating current (AC) inputted from two first nodes into a direct current to be outputted via two second nodes, and wherein the direct current is smoothed by the integrated passive device; and
a plurality of light emitting diodes, connected with each other in series or parallel and applied with the direct current, for lightening.

2. The light emitting diode device according to claim 1, further comprising a Zener diode, formed on the substrate and connected with the integrated passive device via the second nodes, for regulating the direct current.

3. The light emitting diode device according to claim 2, further comprising a varistor, connected with the Zener diode in parallel, for protecting the light emitting diode device from surges.

4. The light emitting diode device according to claim 1, wherein the integrated passive device comprises at least one capacitor connected with the bridge rectifier in parallel and at least one resistor connected with the bridge rectifier in series or parallel.

5. The light emitting diode device according to claim 1, wherein the integrated passive device comprises at least one inductor connected with the bridge rectifier in series and at least one resistor connected with the bridge rectifier in series or parallel.

6. The light emitting diode device according to claim 1, wherein the integrated passive device comprises at least one capacitor connected with the bridge rectifier in parallel, at least one inductor connected with the bridge rectifier in series, and at least one resistor connected with the bridge rectifier in series or parallel.

7. The light emitting diode device according to claim 1, wherein the substrate is made of glass, silicon, ceramic material or printed circuit board.

8. The light emitting diode device according to claim 1, wherein the substrate has a plurality of cavities to accommodate the light emitting diodes.

9. The light emitting diode device according to claim 1, wherein the rectifying diodes are light emitting diodes.

10. The light emitting diode device according to claim 1, wherein the rectifying diodes are formed integratedly or discretely.
